(19) United States
(12) Patent Application Publication
(10) Pub. No.: US 2005/0092728 A1
(43) Pub. Date: May 5, 2005

(54) Resistance welding electrode and associated manufacturing method

(76) Inventors: Fabrice Barbeau, Chalons en Champagne (FR); Jean Claude Aeschbacher, Ville en Selve (FR)

Correspondence Address: LADAS & PARRY LLP, 224 SOUTH MICHIGAN AVENUE, SUITE 1200, CHICAGO, IL, 60604, US

(21) Appl. No.: 10/937,528

(22) Filed: Sep. 9, 2004

(30) Foreign Application Priority Data
Sep. 10, 2003 (FR) 03 10640

(51) Int. Cl. H05B 1/00; B23K 1/00

(52) U.S. Cl. 219/229; 219/56

(57) ABSTRACT

The invention relates to a resistance welding electrode, characterised in that it comprises a core (2) and a shell (3) formed by two different copper alloys, the metallurgical bond between the core (2) and the shell (3) being thin, typically of around one micron.

The invention relates to the technical field of resistance welding electrodes.

Prior art already states a large number of designs and manufacturing methods for such electrodes.

The documents cited hereafter serve to illustrate this diversity of technical solutions.

Document FR 2.424.093 RENAULT describes a welding electrode comprising a cylindrical copper-chromium or copper-chromium-zirconium body on the end of which is fixed a pellet of tungsten and copper dense pseudo-alloy, fixing being achieved by electron bombardment, laser or friction. Such prior achievement is presented as an improvement to copper alloy electrodes with high copper contents, such as copper-chromium with 1% chromium or copper-chromium-zirconium with 1% chromium and a maximum of 0.10% zirconium, an improvement that reduces risks of adherence and loading during resistance welding of sheet steel that is galvanised, electro-zinc plated, aluminized, lead-coated or covered with a metal-organic coating. Tungsten and copper pseudo-alloy is obtained by powder metallurgy and contains between 60 and 80% tungsten.

Document EP 0.493.194 SOLLAC describes a resistance welding electrode comprising a first section made from copper or copper-based alloy, for example 0.1% zirconium, 1% chromium and 98.9% copper and a second section titanium nitride or molybdenum. The first part is diffusion welded on the second part. In one embodiment, the first part is cylindrical with a diameter D and the second part is formed from a cylinder of diameter inferior to D, along with a truncated cone connecting the two cylinders. This prior embodiment is presented as an improvement to bare copper electrodes, or to electrodes fitted with a copper-plated graphite pellet, or to thin layers such as titanium nitride or molybdenum, an improvement designed to increase the service life of the electrodes, in particular during welding zinc-sheet steel, titanium nitride or molybdenum-coated, these electrodes being chemically inert with respect to zinc-plate sheet steel.

Document FR 2.361.967 describes an electrode with a copper or copper alloy body of which part is coated with nickel or beryllium, cobalt, iron and the high melting point alloys of these metals, this electrode body being, furthermore, hammered with shot, for example by shot blasting using aluminium oxide shot, prior to galvanoplastic coating, for example with a layer of nickel.

Document FR 2.373.354 NIPPERT describes a hollow welding electrode, a cooling fluid being introduced into the electrode's internal cavity, this electrode comprising a disposable tip and a reusable shank, in a similar manner to that described in particular in American patents published under numbers: U.S. Pat. Nos. 2,138,388, 2,257,566, 2,402,646, 2,411,859, 2,437,740, 2,440,463, 2,472,173, 2,761,973, 2,780,718, 2,795,688, 2,796,514, 2,829,239, 3,310,087, 3,909.581.

In these prior American documents, assembly of the tip onto the shank is achieved in one of the following manners:
brackets or screws;
lock-in;
brazing;
welding,
tight adjustment.

Document FR 2.373.354 describes the use of a copper-aluminium alloy GLID COPPER, obtained by internal oxidation (see U.S. Pat. No. 3,779,714, U.S. Pat. No. 3,884,876, U.S. Pat. No. 3,893,841), to form the tip of a bimetallic electrode soldered onto an extruded copper shank.

More precisely, a billet of copper and a billet of GLID COPPER are nested, the assembly being heated to 732° C. and soldered to form an extrusion blank, subjected to reverse extrusion and forming the electrode's internal cavity.

Document FR 2.670.699 SOLLAC describes a welding electrode comprising a hollow cylindrical body soldered to a copper graphite pellet, pellet obtained by hot impregnation of copper into a graphite bar, or by sintering.

Document FR 2.771.038 SOLLAC presents a comparison of HB hardness, tensile strength and electrical conductivity of Cu—Cr, Cu—Cr—Zr, Cu—Ag, W—Cu, resistance welding electrodes and describes a thermo-mechanical copper alloy treatment leading to hardening by precipitation and grain refining to produce a resistance welding electrode.

Document U.S. Pat. No. 3,363,086 describes a copper welding electrode coated with rhodium or rhenium, or fitted with a force-inserted rhodium or rhenium pellet.

Document U.S. Pat. No. 3,592,994 recalls the contradictory requirements that materials making up welding electrodes must meet.
high hot mechanical strength, which is not the case of copper alloys;
high electrical and thermal conductivity, which is the case of copper alloys.

This document U.S. Pat. No. 3,592,994 presents Cr—Cu alloys (with Be, Co and Zr additions) as alternatives and describes the implementation of mechanical reinforcement inserts made from copper-tungsten, tungsten or molybdenum.

Reference can also be made to American patents published under numbers: U.S. Pat. Nos. 3,969,156, 4,071,947, 4,288,024, 4,478,787, 4,588,870, 5,334,814, 5,611,945, 5,914,057, 5,844,194, 6,047,471 and 6,225,591, along with document EP 0.097.306.

The applicant has observed that prior bimetallic or bi-material electrode manufacturing techniques present the following drawbacks:
presents an interface creating an electrical resistance between the electrode's tip and body;
self-expulsion of tungsten, molybdenum or tantalum inserts following relaxation of constraints at the core of the electrode during welding cycles.
high cost of tantalum, tungsten or graphite copper material inserts.

Insert self-expulsion is all the more frequent that the refractory inserts possess low thermal and electrical conductivity, thus leading to their overheating. This is all the more localised that the inserts are conventionally inert with respect to copper, such that they are only connected to the copper electrode body by their forced mechanical insertion.

Attachment of a refractory pellet requires either the use of a filler material, for example for soldering, or the use of expensive technical means such as electron bombardment or lasers. Although these pellets offer a good hot mechanical strength, this is at the expense of good electrical conductivity.

These pellets cannot be straightened in the event of buckling and stress concentrations are created between pellet and electrode body due to significant differences in thermal expansion coefficient between the materials making up the body and the electrode pellet.

The applicant sought to provide a resistance welding electrode exempt from the drawbacks of prior known electrodes, this electrode displaying a low tendency to buckle, that is to say to collapse onto its active surface, along with low sensitivity to brass coating and extended service life this electrode comprises at least two materials, one of which forms the electrode's active surface, possessing high thermal and electrical conductivity, the other material being inexpensive and forming the majority of the electrode's volume. The risk of loss of cohesion between these two materials during operation is very low, if not nil.

For this purpose, the invention is related, in one respect, to a resistance welding electrode comprising a core and shell formed of two different copper alloys, the metallurgical connection between the core and shell being thin, typically of the micron order, with no filler metal.

The electrode presents, according to various implementations, the following properties, otherwise combined:
the metallic connection between core and shell is provided, at least in part, by a solid solution;
the alloy comprising the core is a dispersoid copper-alumina alloy or a copper alloy containing less than 1% aluminium, boron, carbon, oxygen and titanium addition;
the alloy making up the shell is a copper-chromium or copper-chromium-zirconium alloy;
the core is axial or off-centre with respect to the shell;
the shell is generally cylindrical in shape, with the truncated cone-shaped front end, the core extending beyond the shell to form the electrode's front surface;
the core possesses a truncated front end extending between the substantially transversal active surface and the truncated cone-shaped front end of the shell;
it comprises a radiator, essentially made up of the core alloy.

According to a second embodiment, the invention relates to a manufacturing method for an electrode as presented above, this method comprising a bi-material billet extrusion step, obtained by forceful insertion of an internal alloy billet, used to form the core, into an alloy tube or hollow body used to form the electrode's shell.

The electrode manufacturing method presents, depending on the implementations, the following properties that may otherwise be combined:
the bi-material billet is extruded at a temperature within a range of 860 to 880° C.;
extrusion is performed using a flat or conical feeder, with water tempering;
the internal alloy billet used to form the core is obtained by extrusion of a copper container in which is place a powder whose composition corresponds to the core alloy;
the inner billet is extruded at a temperature of between 700 and 900° C. (and more particularly at approximately 750° C.);
the inner alloy billet forming the core is obtained by cold compaction of a powder, in an enclosure made of pure or weakly alloyed copper, at a temperature of between 700 and 900° C., more particularly at approximately 870° C.;
the tube forming the shell is obtained by extrusion, the inner diameter of which being a few millimetres less that that of the alloy billet forming the core, the tube is bored, leaving a non-bored section to block the inner billet.
the hollow body forming the electrode shell is obtained by hot press expulsion;
it comprises a drawing step, performed under cold conditions, or at a temperature inferior to 400° C., of the bar resulting from extrusion of the bi-material billet.
it comprises a cold hammering or machining step of the drawn bar, such as to form a truncated cone-shaped end for the electrode;
the diameter of the circumscribed outer circle of the bi-material billet is at least five times larger than the circumscribed outer circle of the bi-material bar obtained by drawing;
the ratio of inner billet to tube or hollow body cross sections is approximately identical to the ratio of core to shell cross sections;
the alloys making up the bi-material billet to draw are not degassed or confined under controlled atmosphere.

Other purposes and advantages of the invention shall appear with the following description of embodiments, given for example purposes, description that shall be given with reference to the appended drawings in which:

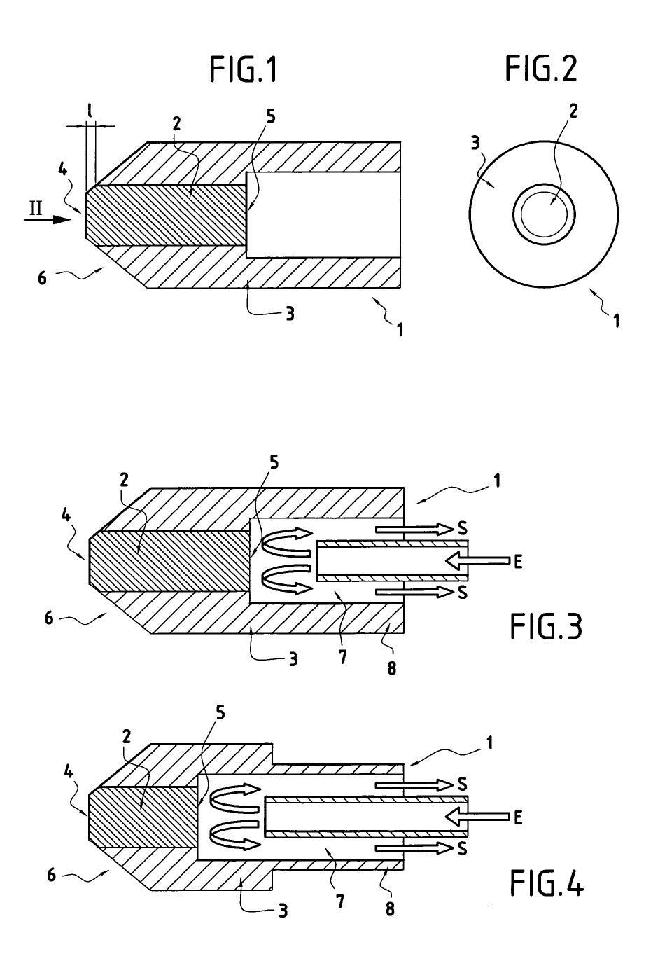

FIG. 1 is a diagrammatic longitudinal cross-section of a resistance welding electrode according to the invention;

FIG. 2 is a side view according to arrow II of FIG. 1;

FIG. 3 is a similar view to FIG. 1, of an electrode with a female tip;

FIG. 4 is a similar view to FIGS. 1 and 3, of an electrode with a male tip;

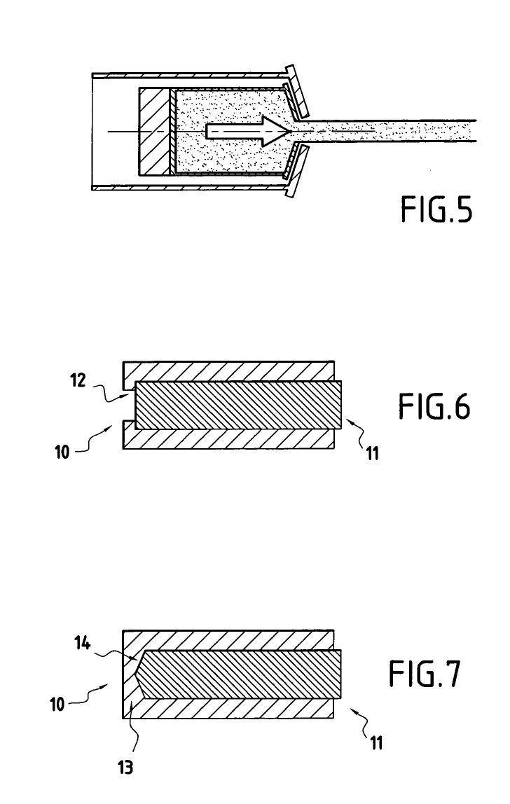

FIGS. 5, 6 and 7 are diagrammatic views of three steps of a method for the manufacture of resistance welding electrodes according to the invention.

Reference is first made to FIGS. 1 and 2.

Electrode 1 possesses a core 2 and a shell 3. The active surface 4 of the electrode 1 is formed by a transversal surface of the material making up the core 2. This active surface 4 is designed to enter into contact, under pressure, with the material to weld.

This active surface undergoes intense thermal cycles during welding during which the surface of electrode 1 can reach 900° C. This active surface 4 is also subjected to brass coating. When welding sheet steel, the clamping force can reach the range of 900 deca Newton.

The radiator 5 of electrode 1 is made up of the same material making up the core 2, the rest of the electrode structure being mainly comprised of envelope 3 material.

As already known per se, the electrode 1 is presented in the general shape of a cylindrical body with a truncated cone end. In the embodiments shown in FIGS. 1 to 4, the core 2 and shell 3 are concentrically arranged, the core 2 protruding by length 1 from the shell 3, in the end truncated cone-shaped part 6 of electrode 1.

In other embodiments, not shown here, the core 2 is off-centre with respect to the shell 3.

Electrode cooling is guaranteed, in a known manner, by circulation of a fluid such as water, through the rear part of the electrode 7. A skirt 8 allows the electrode 1 to be fitted onto the welding tool, along with the proper positioning of the active surface 4. Cooling fluid circulation is represented by the inlet E and outlet S arrows on FIGS. 3 and 4.

The material making up the core 2, hereafter referred to as Bicop, is a dispersoid copper-based alloy.

In one embodiment, this Bicop contains up to 0.6% alumina Al₂O₃. In another embodiment, this Bicop contains less than 1% aluminium, boron, carbon and oxygen, titanium micro-addition.

The following table presents the Bicop properties, in comparison to alloys conventionally used for resistance welding electrodes: Cu—Zr, Cu—Cr—Zr, and GlideCop type copper alloy.

| | | | | | | | | |
|---|---|---|---|---|---|---|---|---|
| | | Electrical | Conductivity | Hardness | UTS | Elongation | Service | |
| Alloys | Annealing ° C. | Sm/mm² | % IACS | HB | MPa | % | life | Bonding |

| | | | | | | | | | |
|---|---|---|---|---|---|---|---|---|---|
| Bicop | 950 | 47 | 81 | 140-155 | 450-510 | 18 | +++++ | +++++ | |
| GlideCo | 900 | 45 | 78 | 140-155 | 450-540 | 18 | ++++ | ++++ | |
| p A160 | | | | | | | | | |
| CuCrZr | 450 | 45 | 78 | 150-170 | 370-500 | 18 | ++++ | +++ | |
| CuZr | 450 | 51 | 85 | 110-130 | 320 | 18 | +++ | +++ | |
| Cu | 300 | 58 | 100 | <105 | <<<300 | 20-45 | −−− | −−− | 1 |

As shown in this table, the Bicop demonstrates good bonding strength and high levels of electrical and thermal conductivities. It annealing temperature is of around 950° C. such that the Bicop is able to withstand, without softening, thermal cycles up to 900° C. The electrode 1 demonstrates low sensitivity to brass coating, the lack of Bicop softening and its low brass coating sensitivity render the electrode 1 resistant to buckling, the active surface area 4 varying little under the effect of clamping pressure during welding.

The collapse of the active surface 4, conventionally observed in prior art electrodes, lowers the quality of welding, the increase in active surface reducing welding current density.

The copper-alumina Bicop can be obtained by powder metallurgy, or by internal oxidation. The copper-aluminium-boron-carbon-oxygen-titanium Bicop can be obtained by high energy grinding or mechanosynthesis.

The shell 3 of the electrode 1 is made from copper-chromium or copper-chromium-zirconium alloy. This shell thus possesses mechanical, electrical and forming properties that differ significantly from those of the core.

The applicant has striven to achieve an electrode with a general structure as presented above, in which there is a fine, regular, homogeneous and continuous metallurgical bond between core and shell, this bond being achieved without addition of metal and not being comprised of fragile chemical reactions such as oxidation layers, intermetallic or ceramic compounds.

Such a quality of metallurgical bond avoids thermal transfer resistance between the core and the shell, along with interfacial electrical resistance that can lead to internal ohmic heating of the electrode.

The applicant has striven to ensure that this metallurgical bond is not subject to softening during welding cycles, or to the generation of stresses causing, as in prior art electrodes, risks of insert disassembly.

Metallurgical bonds achieved by soldering lead to electrical resistance and are subject to softening.

This fine, regular, homogeneous and continuous metallurgical bond between core and shell is achieved by the implementation of a method described hereafter.

First Step—Powder Compaction

### FIRST EMBODIMENT OF THIS FIRST STEP

A powder, whose composition corresponds to the Bicop, is lightly compacted by vibration in a sealed copper container. This operation is performed under controlled atmosphere, preferably nitrogen or argon.

The billet is fitted with an excess pressure release system and placed in an extrusion press heating furnace to be heated to between 700 and 900° C.

The applicant has observed that it is preferable to maintain the heating temperature below 900° C. approximately, in order to maintain good Bicop mechanical properties. Advantageously, this heating temperature should be of approximately 750° C.

The billet is held at this temperature for a 1-hour homogenisation period, then extruded by direct or reverse extrusion through a flat (to remove the copper shell) or conical extrusion die on an extrusion press.

When extrusion is performed using a conical die, 180 mm diameter billets can be reduced to a diameter of 35 mm, 33 mm and 30 mm. The extrusion press piston advance speed can be of between 2 mm and up to 60 mm per second, a speed of 30 mm per second giving industrially acceptable results.

When the extrusion ratios are of approximately 2 to 3, a preheated pure copper or low alloy billet should be placed in front of the billet containing the powder, of the same diameter, but of short length, around 100 mm or less. This pure or low alloy copper billet increases the extrusion pressure, thus guaranteeing good Bicop powder compaction.

As a variant, in view of removing the need for this pure or low alloy copper billet needing to be eliminated from the extruded product, extrusion is performed in a continuous manner through a conical extrusion die, the next billet pushing the previous one out of the die.

The resulting extruded product possesses a density of 1 with respect to the massive product identical to the copper alloy, the resulting mechanical properties being typically of 140 HB and 410 MPa tensile strength, for an elongation of 12%.

### SECOND EMBODIMENT OF THIS STEP

The powder, whose composition corresponds to the Bicop, is cold compacted, for example by isostatic compaction, cold closed matrix pressing or cold extrusion, preferably with a pure or low alloy copper shell.

The resulting product therefore possesses a density of 70 to 80%, non-brittle. The resulting billet is placed in an extrusion press heating furnace to be heated to between 700 and 900° C., a temperature of 870° C. having given industrially satisfactory results.

The remaining extrusion operation can be performed as described previously in the first embodiment of this first manufacturing step.

Second Step

A hollow Cu—Cr, or Cu—Cr—Zr alloy billet is created to make up the shell 3 of the electrode 1.

According to one embodiment, this hollow billet is directly produced in the shape of tubes with an inner diameter of at least 5 mm less than the pre-extruded Bicop billet, the exact dimensions being achieved by boring, insertion of the Bicop billet being performed dry using force.

In another embodiment, a solid billet is first heated at between 900 and 1050° C. When the material has reached this temperature, it is placed in a matrix, a centred punch with a diameter inferior to that of the Bicop billet perforating the copper alloy billet, the material being expelled to form a hollow body, this hollow body being bored and the insertion of the Bicop billet into this hollow body being performed dry with force.

FIGS. 6 and 7 illustrate the product obtained after this second manufacturing step, according to the first and second variants respectively.

In FIGS. 6 and 7, the front part 10 of the bi-material billet is that which shall be extruded first during the third manufacturing step, the rear part being that which shall be in contact with the dummy block.

As shown in FIG. 6, the copper, copper-chromium or copper-chromium-zirconium tube is bored, leaving a not-bored section 12 used to block the inner billet. This non-bored section 12 is a few millimetres long.

In the embodiment shown in FIG. 7, the copper, copper-chromium or copper-chromium-zirconium hollow body is bored to the exact dimension of the inner Bicop billet, with a bottom 13 of a few millimetres in thickness, defining a base wall 14 for the hollow body, whose shape is complementary to the inner Bicop billet.

After force fitting the Bicop billet into the copper, copper-chromium or copper-chromium-zirconium hollow tube or hollow body, this inner Bicop billet protrudes advantageously from the rear part 11 of the bi-material billet.

Third Step

The bi-material billet resulting from the second step and represented diagrammatically in FIGS. 6 and 7, is placed in an extrusion press preheating furnace.

Direct or indirect extrusion can be performed through a flat or conical die.

The advance speed of the extrusion press piston can be of between 10 and 80 mm per second, a speed of 20 mm per second giving good industrial results. The single hole extrusion die possesses an inner diameter such that the extrusion ratio is high, of approximately 20 to 45 mm, the outer diameter of the bi-material billet being approximately 170 mm.

Extrusion temperature is of 860 to 880° C.

The applicant has observed that the resulting product possesses a fine, regular, homogeneous and continuous metallurgical bond between the Bicop forming the core 2 and the copper, copper-chromium or copper-chromium-zirconium alloy forming the shell 3 of the electrode 1, the transition zone between the two alloys being very small, typically less than one micron.

Fourth Step

The bar obtained by extrusion during the third step is drawn cold, or at a temperature inferior to 400° C., with no loss of cohesion nor periodic faults in the material.

Fifth Step

The electrode 1 is obtained, for example, by cold hammering or machining, with no loss of cohesion nor fault being observed by the applicant in the electrode core.

No Kirkendal void was observed at the interface between core and shell. Diffusion tests performed by the applicant demonstrated that the diffusion speed between the material making up the electrode core and the material making up the electrode shell is very low and rapidly tends towards 0, the solid solution zone remaining continuous is thin.

When a bi-material bar, obtained from the second step of the above-described method, is cut lengthwise along its middle, no loss of cohesion occurs on relaxation of binding forces.

The thermal cycles during welding, including those up to 900° C., can cause a softening of the copper-chromium-zirconium, copper-chromium or copper-based alloy making up the shell 3.

No loss of cohesion, however, was observed between core and shell.

1-21. (canceled)

22. A resistance welding electrode comprising a core and a shell, the core and the shell being formed of two different copper alloys and having a thin metallurgical bond therebetween.

23. The resistance welding electrode according to claim 22, wherein said thin metallurgical bond is approximately one micron thick.

24. The resistance welding electrode according to claim 22, wherein said metallurgical bond is guaranteed, at least in part, by a solid solution.

25. The resistance welding electrode according to claim 22, wherein the core copper alloy is a dispersold copper-alumina alloy.

26. The resistance welding electrode according to claim 22, wherein the core copper alloy contains les than 1% by weight aluminum, boron, carbon, oxygen and titanium.

27. The resistance welding electrode according to claim 22, wherein the shell alloy is a copper-chromium alloy.

28. The resistance welding electrode according to claim 22, wherein the shell alloy is a copper-chromium-zirconium alloy.

29. The resistance welding electrode according to claim 22 wherein the core is axially aligned with respect to the shell.

30. The resistance welding electrode according to claim 22 wherein the core is aligned off-center with respect to the shell.

31. The resistance welding electrode according to claim 22 wherein the shell is generally cylindrical in shape, and the electrode has a truncated cone-shaped front surface with the core protruding from the shell.

32. The resistance welding electrode according to claim 31 wherein the core has a truncated cone-shaped front end extending from the shell having a truncated cone-shaped front end.

33. The resistance welding electrode according to claim 22 further comprising a radiator made essentially from the same alloy as the core.

34. A method of manufacturing a resistance welding electrode having a core and a shell, the method comprising a bi-material billet extrusion step wherein an inner alloy billet making up the core is inserted into an alloy tube making up the shell of the electrode.

35. The method according to claim 34 further comprising the step of forming the core and the shell from two different copper alloys.

36. The method according to claim 34 further comprising the step of forming the bi-material billet at a temperature between 860 and 880° C.

37. The method according to claim 34 further comprising the steps of performing the extrusion using a flat extrusion die, and water tempering the electrode.

38. The method according to claim 34 further comprising the step of performing the extrusion using a conical extrusion die, and water tempering the electrode.

39. The method according to claim 34 further comprising the step of forming the core by extrusion of a copper container and placing the core alloy in powder form within the container.

40. The method according to claim 39 further comprising the step of forming the core at a temperature between 700 and 900° C.

41. The method according to claim 39 further comprising the step of forming the core at a temperature of approximately 750° C.

42. The method according to claim 34 further comprising the step of forming the core by compaction of a core alloy powder in a copper enclosure heated to a temperature between 700 and 900° C.

43. The method according to claim 34 further comprising the step of forming the core by compaction of a core alloy powder in a copper alloy enclosure heated to a temperature between 700 and 900° C.

44. The method according to claim 42 wherein the enclosure is heated to a temperature of approximately 870° C.

45. The method according to claim 43 wherein the enclosure is heated to a temperature of approximately 870° C.

46. The method according to claim 34 further comprising the step of forming the shell by extrusion, the shell having an inner bore that has a diameter smaller than an outer diameter of the core, and the shell having a non-bored portion to block the core.

47. The method according to claim 34 further comprising the step of forming the shell by hot press expulsion.

48. The method according to claim 34 further comprising a cold drawing step of the bi-material billet at a temperature less than 400° C.

49. The method according to claim 48 wherein the cold drawing step comprises a cold hammering or machining step of the bi-material billet to form a truncated cone-shaped end.

50. The method according to claim 34 wherein the outer diameter of the electrode is at least five times larger before the bi-material billet extrusion step than after.

51. The method according to claim 34 wherein a cross-sectional ratio of the core and shell is approximately the same before the bi-material billet extrusion step as after.
